(19) United States
(12) Patent Application Publication
(10) Pub. No.: US 2007/0015472 A1
(43) Pub. Date: Jan. 18, 2007

(54) Multimode transmitter, module, communication device and chip set

(76) Inventors: Simo Murtojarvi, Salo (FI); Tapani Ekman, Salo (FI)

Correspondence Address: Hollingsworth & Funk, LLC;Suite 125, 8009 34th Avenue South, Minneapolis, MN, 55425, US

(21) Appl. No.: 11/182,492

(22) Filed: Jul. 15, 2005

(51) Int. Cl. H04B 1/02; H04B 1/66

(52) U.S. Cl. 455/102

(57) ABSTRACT

The invention is related to a multimode transmitter comprising: generating means for generating signals according to different communication standards; amplifying means for amplifying the signals generated according to the different communication standards; and conveying means for conveying the signals from the generating means to the amplifying means, the conveying means being shared by the signals generated according to the different communication standards.

### FIELD

The invention relates to a multimode transmitter, module, communication device and a chip set.

### BACKGROUND

Nowadays, there exist different standards for delivering data in wireless communication systems. Therefore there is a need for multimode user devices (or communication devices) which support various standards. At the moment, some of the most commonly used standards are Global System for Mobile Communications (GSM), Enhanced Data Rates for Global Evolution (EDGE), Wide Band Code Division Multiple Access (NCDMA) and Code Division Multiple Access (CDMA).

In prior art, solutions to arrange transmitter parts required by different standards in a user device have been presented, but there is still a need to simplify the structure and thus make it possible to produce lighter user devices with smaller dimensions and to save in manufacturing costs.

### BRIEF DESCRIPTION OF THE INVENTION

According to an aspect of the invention, there is provided a multimode transmitter comprising: generating means for generating signals according to different communication standards; amplifying means for amplifying the signals generated according to the different communication standards; and conveying means for conveying the signals from the generating means to the amplifying means, the conveying means being shared by the signals generated according to the different communication standards.

According to an aspect of the invention, there is provided a multimode transmitter comprising: generating means for generating signals according to different communication standards; dividing means for dividing signals into modulation groups on the basis of the used modulation method, which modulation method is determined by a communication standard; amplifying means for amplifying the signals generated according to the different communication standards: combining means for combining signals from the modulation groups into a common signal to be conveyed to the amplifying means; and conveying means for conveying the common signal to the amplifying means.

According to an aspect of the invention, there is provided a module comprising: generating means for generating signals according to different communication standards; amplifying means for amplifying the signals generated according to the different communication standards; and conveying means for conveying the signals from the generating means to the amplifying means, the conveying means being shared by the signals generated according to the different communication standards.

According to an aspect of the invention, there is provided a module comprising: generating means for generating signals according to different communication standards; dividing means for dividing signals into modulation groups on the basis of the used modulation method, which modulation method is determined by a communication standard; amplifying means for is amplifying the signals generated according to the different communication standards; combining means for combining signals from the modulation groups into a common signal to be conveyed to the amplifying means; and conveying means for conveying the common signal to the amplifying means.

According to an aspect of the invention, there is provided a communication device comprising: generating means for generating signals according to different communication standards; amplifying means for amplifying the signals generated according to the different communication standards; and conveying means for conveying the signals from the generating means to the amplifying means, the conveying means being shared by the signals generated according to the different communication standards.

According to an aspect of the invention, there is provided a communication device comprising: generating means for generating signals according to different communication standards; dividing means for dividing signals into modulation groups on the basis of the used modulation method, which modulation method is determined by a communication standard; amplifying means for amplifying the signals generated according to the different communication standards; combining means for combining signals from the modulation groups into a common signal to be conveyed to the amplifying means; and conveying means for conveying the common signal to the amplifying means.

According to an aspect of the invention, there is provided a chip set comprising: generating means for generating signals according to different communication standards; amplifying means for amplifying the signals generated according to the different communication standards; and conveying means for conveying the signals from the generating means to the amplifying means, the conveying means being shared by the signals generated according to the different communication standards.

According to an aspect of the invention, there is provided a chip set comprising: generating means for generating signals according to different communication standards; dividing means for dividing signals into modulation groups on the basis of the used modulation method, which modulation method is determined by a communication standard; amplifying means for amplifying the signals generated according to the different communication standards; combining means for combining signals from the modulation groups into a common signal to be conveyed to the amplifying means; and conveying means for conveying the common signal to the amplifying means.

According to an aspect of the invention, there is provided a multimode transmitter configured to: generate signals according to different communication standards, amplify the signals generated according to the different communication standards; and convey the signals from the generating means to the amplifying means, the conveying means being shared by the signals generated according to the different communication standards.

According to an aspect of the invention, there is provided a multimode transmitter configured to: generate signals according to different communication standards; divide signals into modulation groups on the basis of the used modulation method, which modulation method is determined by a communication standard; amplify the signals generated according to the different communication standards; combine signals from the modulation groups into a common signal to be conveyed to the amplifying means; and convey the common signal to the amplifying means.

According to an aspect of the invention, there is provided a module configured to: generate signals according to different communication standards; amplify the signals generated according to the different communication standards; and convey the signals from the generating means to the amplifying means, the conveying means being shared by the signals generated according to the different communication standards.

According to an aspect of the invention, there is provided a module configured to: generate signals according to different communication standards; divide signals into modulation groups on the basis of the used modulation method, which modulation method is determined by a communication standard; amplify the signals generated according to the different communication standards; combine signals from the modulation groups into a common signal to be conveyed to the amplifying means; and convey the common signal to the amplifying means.

According to an aspect of the invention, there is provided a communication device configured to: generate signals according to different communication standards; amplify the signals generated according to the different communication standards; and convey the signals from the generating means to the amplifying means, the conveying means being shared by the signals generated according to the different communication standards.

According to an aspect of the invention, there is provided a communication device configured to: generate signals according to different communication standards; divide signals into modulation groups on the basis of the used modulation method, which modulation method is determined by a communication standard; amplify the signals generated according to the different communication standards; combine signals from the modulation groups into a common signal to be conveyed to the amplifying means; and convey the common signal to the amplifying means.

According to an aspect of the invention, there is provided a chip set configured to: generate signals according to different communication standards; amplify the signals generated according to the different communication standards; and convey the signals from the generating means to the amplifying means, the conveying means being shared by the signals generated according to the different communication standards.

According to an aspect of the invention, there is provided a chip set configured to generate signals according to different communication standards; divide into modulation groups on the basis of the used modulation method, which modulation method is determined by a communication standard; amplify the signals generated according to the different communication standards; combine signals from the modulation groups into a common signal to be conveyed to the amplifying means; and convey the common signal to the amplifying means.

The invention provides several advantages.

An embodiment of the invention provides a multimode transmitter structure with reduced complexity: for example, the number of power amplifiers is decreased and no band pass filters are needed.

### LIST OF DRAWINGS

In the following, the invention will be described in greater detail with reference to the embodiments and the accompanying drawings, in which

FIG. 1 shows a simplified example of a communication system;

FIG. 2 illustrates an example of a prior art transmitter,

FIG. 3 illustrates an example of a multi-architecture multimode transmitter schematic;

FIG. 4 illustrates an example of an implementation of a polar transmitter;

FIG. 5 illustrates an example of a polar implementation that can be used instead of an in-phase and quadrature (I/Q) modulator;

FIG. 6 illustrates an example of an implementation for generating frequency modulation with an I/Q-modulator;

FIG. 7 illustrates an example of a configuration for producing modulation used in an EDGE system that offers a potential for decreasing the amount of needed phase and amplitude pre-distortion;

FIG. 8 illustrates another example of an implementation for generating a modulated signal with an I/Q-modulator;

FIG. 9 illustrates an example of a prior art transmitter providing 3 GSM bands and 1 WCDMA band;

FIG. 10 illustrates an example of a transmitter according to an embodiment of the invention providing 4 GSM bands, 4 CDMA bands and 5 WCDMA bands;

FIG. 11 illustrates an example of a part of a network element; and

FIG. 12 illustrates an example of a communication device.

### DESCRIPTION OF EMBODIMENTS

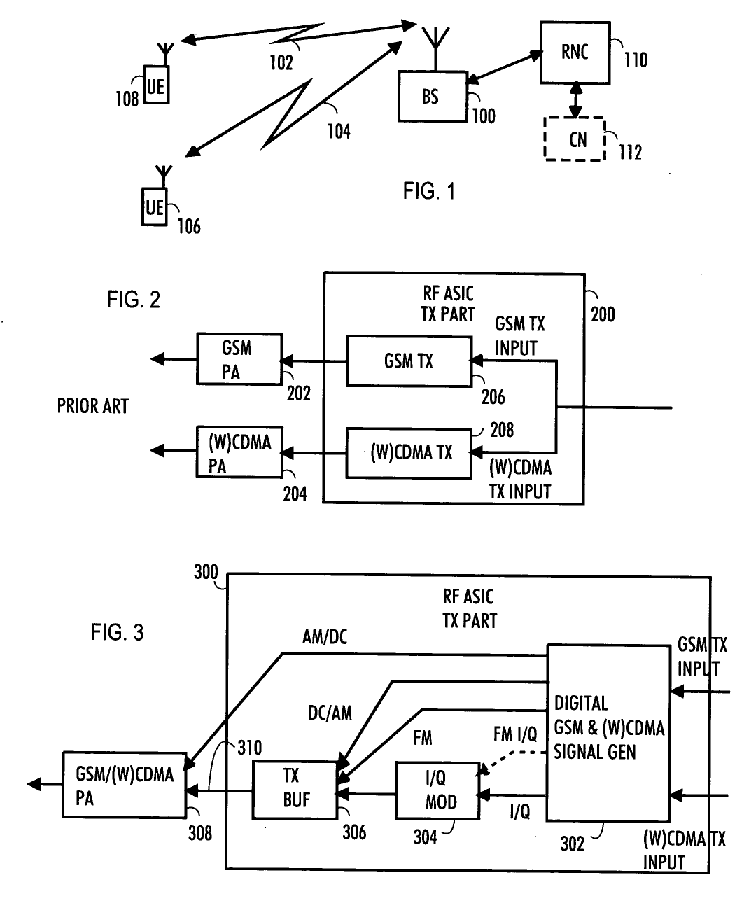

With reference to FIG. 1, we examine an example of a communication system to which embodiments of the present invention can be applied. The embodiments can be applied to various communication systems. Examples of such communication systems are a Universal Mobile Telecommunications System (UMTS) radio access network and Global System for Mobile Communications (GSM)/Enhanced Data Rates for Global Evolution (EDGE) systems. The UMTS uses wideband code division multiple access (WCDMA) technology and can also offer real-time circuit and packet switched services.

The embodiments are not, however, restricted to the systems given as examples but a person skilled in the art may apply the solution to other communication systems provided with the necessary properties.

It is clear to a person skilled in the art that the method according to the invention can be applied to systems utilizing different modulation methods or air interface standards.

FIG. 1 is a simplified illustration of a part of a digital data transmission system to which the solution according to the invention is applicable. This is a part of a cellular radio system, which comprises base station (or node B) 100, which has bidirectional radio links 102 and 104 to communication devices 106 and 108. The communication devices may be fixed, vehicle-mounted or portable. The base station includes transceivers, for instance. From the transceivers of the base station, a connection is provided to an antenna unit, which establishes the bi-directional radio links to the communication device. The base station is further connected to controller 110, such as a radio network controller (RNC), which transmits the connections of the devices to other parts of the network. The radio network controller controls in a centralized manner several base stations connected to it. The radio network controller is further connected to core network 112 (CN). Depending on the system, the counterpart on the CN side can be a mobile services switching centre (MSC), a media gateway (MGW) or a serving GPRS (general packet radio service) support node (SGSN).

The radio system can also communicate with other networks, such as a public switched telephone network or the Internet.

The size of communication systems can vary according to the data transfer needs and to the required coverage area.

Next, an example of a prior art transmitter is explained in further detail by means of FIG. 2. A common prior art multimode user device, such as a mobile phone, has three bands for a GSM/EDGE transmission (one lower band and two higher bands) and one band for a WCDMA transmission. In this configuration, two transmitter band filters, one for the lower band of a GSM/EDGE transmission and one for a WCDMA transmission, are required (not shown in FIG. 2). A switching regulator is also used for a WCDMA transmitter power amplifier in order to increase the efficiency of lower power levels (not shown in the Figure).

FIG. 2 illustrates a simplified transmitter architecture. Transmitter includes radio frequency (RF) application-specific integrated circuit (ASIC) 200. The ASIC comprises separate blocks for generating a GSM signal 206 and a WCDMA signal 208. The GSM signal and the WCDMA signal are conveyed by separate signal paths to power amplifier 202 which is for GSM signals and to power amplifier 204 which is for WCDMA signals.

A problem in an in-phase and quadrature (I/Q) modulator is that in order to achieve the signal-to-noise ratio, target band pass filters have to be used between the I/Q modulator and a power amplifier. The strictest signal-to-noise requirement is for the lower receiver band (800/900 MHz) in the GSM system. However, in order the filter to be efficient, the power amplifier has to be driven in a linear mode to avoid the folding of the noise on a transmission band to a reception band, when the transmitter is using high frequency channels, i.e. channels nearest to the receiver band.

When a signal modulated by a modulation method used in EDGE systems is generated using the Polar method, that is to say that phase and amplitude are modulated separately, phase or frequency modulation can be carried out by a phase lock loop (PLL) or by an offset loop. Such an implementation produces a better signal-to-noise ratio than an I/Q modulator. However, an amplitude modulator is required due to the nature of the signal. Typically, an amplitude modulator increases noise and thus ft deteriorates the overall signal-to-noise ratio.

If the Polar method is used to generate a signal modulated by a modulation method used in EDGE systems, an amplitude modulation modulator is coupled to a frequency modulation modulator, which raises a problem: an amplitude modulation (AM) modulator increases the noise level and a transmission band filter is needed again.

Prior art transmitters, an envelope elimination and restoration (EER) transmitter and a polar transmitter using the Polar method are presented in European Patent Application EP 1225690A3, which is incorporated herein as a reference. These transmitters are quite complicated, since, in order to fulfil the linearity requirements for amplitude modulation and phase modulation, pre-distortion with a feedback loop is required.

A multimode transmitter according to an embodiment utilises a common signal path, a common in-phase and quadrature modulator (I/Q modulator), a common buffer, and a common power amplifier for lower frequency band signals and another similar kind of arrangement for higher frequency band signals. The multimode transmitter also includes a power amplifier control block and amplitude modulation signal path common to both frequency bands.

It is further possible that more common blocks may be used, such as the I/Q-modulator's balance control, common digital-to-analogue converters for I/Q-signals, common I/Q-filters with adaptable bandwidths, common I/Q-modulators, common buffers with adaptable amplification which is adapted in a polar form to attain desired compression and with which power control is performed in a linear mode, common power amplifiers and power amplifier control and a common digital-to-analogue converter in an amplitude modulation branch used in a polar form to convert an amplitude modulation signal into analogue form and in a linear mode to convert power level control to an analogue form.

In an embodiment of the invention, a transmitter including various modulators modulating signals according to different communication standards is presented. One example is a transmitter including both a polar modulator and an in-phase and quadrature (I/Q) modulator. Additionally, common signal paths inside an RF circuit and a common power amplifier for signals according to different standards are provided.

The multimode transmitter may include, for example, means for combining amplitude modulation into frequency modulated signals in a power amplifier, means for conveying frequency modulated signals to a buffer and from the buffer to a power amplifier and means for generating in-phase and quadrature modulation.

Another embodiment of a multimode transmitter may include, for example, means for generating an in-phase and quadrature modulating signal and means for dividing the signal into an amplitude modulating signal component and into a frequency modulated signal component.

Another embodiment of a multimode transmitter may include means for combining amplitude modulation into frequency modulated signals in a power amplifier, means for combining amplitude modulation into a frequency modulated signal in a buffer, means for conveying frequency modulated signals to a buffer and from the buffer to a power amplifier, means for conveying frequency modulating in-phase and quadrature signal components to an in-phase and quadrature modulator and means for generating in-phase and quadrature modulation.

An example of a multi-architecture multimode transmitter schematic is depicted in FIG. 3. In prior art transmitters, saw filters (band pass filters), separate signal paths, separate signal generating means and separate power amplifiers for signals of each standard supported by user devices are necessary.

In the multimode transmitter (or in a multimode radio frequency (RF) ASIC 300) of FIG. 3, there are no saw filters and the whole transmitter uses only two power amplifiers depicted with common block 308. It should be noted that signals that are in accordance with different communication standards may be amplified by using the same power amplifier. In other words, in the embodiment, there are separate amplifiers for upper and lower frequency bands but not for signals modulated in different manners.

Amplifier frequency bands could, for instance, be 824 MHz to 849 MHz and 880 MHz to 915 MHz for a GSM/EDGE/WCDMA/CDMA lower band power amplifier and 1710 MHz to 1785 MHz, 1850 MHz to 1910 MHz and 1920 MHz to 1980 MHz for a GSM/EDGE/WCDMA/CDMA upper band power amplifier.

It is obvious that more bands and systems than depicted in FIG. 3 can be included in the same topology and it is also an option to add more outputs to the RF ASIC 300.

In block 302, conventional I/Q signals are generated in block 304 by using an input signal intended to be transmitted according to the GSM standard and another input signal intended to be transmitted according to the WCDMA standard. The generation of I/Q signals is known in the art and thus it is not explained here in further detail.

After generation, the I/Q signal is divided into an amplitude modulation (AM) signal component and into a signal component to be frequency modulated (FM). The division is also carried out in block 302.

Further in block 302, FM I/Q signals for producing frequency modulation (FM) are generated. The generation of FM I/Q signals is also known in the art.

Then, depending on the communication standard according to which a signal is generated and modulated, there are several options for signal processing:

1) AM and FM signals are combined in power amplifier 308,

2) AM and FM signals are combined in buffer 306,

3) FM signals are conveyed to buffer 306, and from the buffer to power amplifier 308,

4) FM I/Q signals are conveyed to an I/Q modulator. If frequency modulation is performed by using a synthesizer, strict requirements for tolerances of a voltage-controlled oscillator, a loop filter of a phase lock loop, predistortion and amplification of a phase comparator exist. These requirements are not valid if a frequency modulated signal is generated by an I/Q modulator, but instead, the generated signal has a worse signal-to-noise ratio. Hence, depending on the case, a frequency modulated signal is generated either by a synthesizer or an I/Q modulator,

5) conventional I/Q modulation is used,

6) conventional I/Q modulation is used to compress a power amplifier and amplitude modulated signals are combined in a power amplifier 308.

Signal path 310 is an example of conveying means being shared by the signals generated according to the different communication standards. Buffer 306 is an example of combining means for combining signals into a common signal to be conveyed to an amplifier and signal path 310 is an example of conveying means for conveying the common signal to the amplifier.

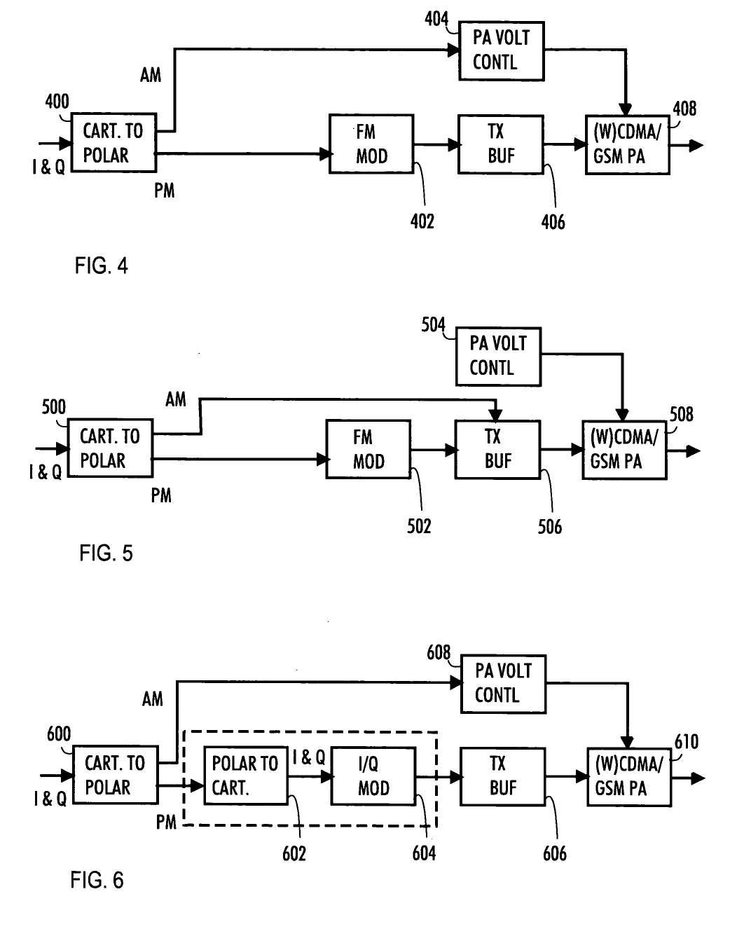

In the following, some examples of implementations of different modulation methods are explained in further detail by means of FIGS. 4 to 8. Is should be noted that a plurality of transmitter structures depicted in FIGS. 4 to 8 are applicable to the same transmitter or a corresponding device.

An exemplary implementation of a GMSK modulated signal is shown in FIG. 4. Since the signal-to-noise ratio requirement is the most challenging to fulfil for a Gaussian minimum-shift keying (GMSK) modulated signal having a high output power and also since efficiency is a very important character, the embodiment typically uses a Polar (EER) architecture for implementing GMSK modulation. Briefly, in the embodiment shown in FIG. 4, GMSK modulation is performed by frequency modulating a voltage controlled oscillator by using a phase lock-loop. Power control, such as ramp-up, power level and power ramp-down are controlled by amplitude modulation generated by a power amplifier.

In block 400, in-phase and quadrature signals are converted to polar form, i.e. to phase and amplitude components. The conversion is known in the prior art. The phase component is pre-distorted in order to compensate distortions caused by a power amplifier (PA) and differentiated to get an input signal to FM modulator 402.

Frequency modulation is carried out in block 402. The frequency modulation can be carried out with a phase-lock loop (PLL) using a sigma-delta modulator in a divider (feedback) chain. A possible pre-emphasis filter is used to compensate for the frequency response of the PLL loop.

The needed FM signal bandwidth of a GMSK modulated signal is quite narrow, making the FM modulation relatively easy to implement. Naturally, instead of a PLL, it is also possible to use so-called two-point FM modulation. In that case, a modulation signal is fed to the PLL's sigma-delta modulator and it is also summed with an input control signal (direct modulation) of a voltage-controlled oscillator (VCO) in an analogous form. Thus modulation seen by the PLL's phase detector can be removed and thus the input signal to a phase comparator is unmodulated.

When the signal amplitude for the direct modulation is correct, the PLL only keeps the center frequency locked. Another option to carry out frequency modulation is offset-loop modulation,

The signal is fed from the FM modulator to a controllable buffer amplifier stage (block 406)

A frequency divider is included in the FM modulator, if a voltage-controlled oscillator (VCO) is at a harmonic of a channel frequency. From the buffer amplifier, the signal is fed to a power amplifier (PA) 408 in such a level that the PA is driven in compression. Both a power ramp-up and a power level adjustment are carried out by controlling the PA's supply voltage with power amplifier voltage controller block 404. The power amplifier voltage controller block can, for example, be a pure Switched Mode Power Supply (SMPS), a linear regulator or a combination of an SMPS and a linear regulator, as described in patent publication U.S. Pat. No. 3,900,823 (Sokal), which is herein taken as a reference.

The power amplifier voltage controller block contains functions that are needed to control the power amplifier, for example adjusting biases, bypassing some amplifier stages, generating a slave amplitude modulation (AM) control signal, etc. If phase and amplitude behaviour of the power amplifier is non-linear against a modulation voltage, amplitude pre-distortion and phase pre-distortion can be used in order to fulfil the requirements set for a switching spectrum.

In order to save current, the input amplitude to the power amplifier can be adjusted with a gain control according to the required output power in such a manner that the wanted compression is maintained.

An implementation of a signal modulated by a modulation method used in EDGE systems is similar to that of FIG. 4. In block 400, in-phase and quadrature signals are converted to polar form, that is to say to phase and amplitude components. The phase component is pre-distorted in order to compensate distortions caused by a power amplifier and differentiated to get an input signal to an FM modulator.

FM modulator 402 is used to generate the needed FM modulation. A frequency modulated transmission signal is then amplified with a buffer amplifier 406 and fed to power amplifier 408 at a level high enough to compress the latter. The amplitude of a signal fed to the power amplifiers input can be changed to different transmission power levels or kept the same. An AM-signal is generated by amplitude modulating a power amplifier signal with a power amplifier voltage controller 404.

The AM path generates a ramp-up to a determined power level of an amplitude modulated and pre-distorted envelope signal. The envelope signal from a power amplifier voltage controller 504 is used to amplitude modulate the power amplifier signal.

FIG. 5 presents an example of a solution to generate modulation with the Polar method in a small signal domain. In block 500, the Cartesian I and Q signals are converted to polar form, i.e. to phase and amplitude signals. The phase signal is differentiated to obtain an FM modulating signal that is fed to FM-modulator 502. From the FM-modulator, the signal is taken to transmitter buffer 506. An AM signal is used to control the transmitter buffer in a way that an AM component is added to a previously frequency modulated signal. In order to compensate for non-linearities in the transmitter buffer, the phase and amplitude predistortions may be used in phase and amplitude paths. From the transmitter buffer, the signal is fed to power amplifier 508. In this case, the power amplifier (PA) is used in a linear mode and power amplifier voltage controller 504 is used to provide the power amplifier with such a Direct Current (DC) voltage level that the needed peak power for a used power level is attained. Amplitude modulation may be added to the operating voltage of a power amplifier.

FIG. 6 shows an exemplary implementation for generating frequency modulation with an I/Q-modulator. In block 600, in-phase and quadrature signals are converted to polar form, that is to say to phase and amplitude components. The phase component is pre-distorted in order to compensate for distortions caused by a power amplifier.

In this case, in Polar to Cartesian conversion block 602, the pre-distorted phase component is converted to in-phase (I) and quadrature (Q) signals which generate a constant amplitude vector with wanted phase rotation. The generated FM I/Q signals are then fed to I/Q modulator 604. In other words, blocks 602 and 604 generate a frequency modulated signal with a constant amplitude. The frequency modulation with an I/Q modulator makes it possible to avoid the need for tight compensations against voltage controlled oscillator tuning sensitivity, a loop filter component of a phase-lock loop and a phase comparison gain.

The modulated transmission signal is then amplified with buffer amplifier 606 and fed to power amplifier 610 at a level high enough to compress the latter. The amplitude of a signal fed to the power amplifier's input can be changed for different transmission power levels or kept the same. The AM signal is fed to power amplifier voltage controller 608 that controls the power amplifier in a similar manner to that of the configuration of FIG. 4. In other words, the envelope signal from a power amplifier (PA) voltage controller is used to amplitude modulate the power amplifier.

The embodiment is suitable for generating modulations used in GSM and EDGE systems,

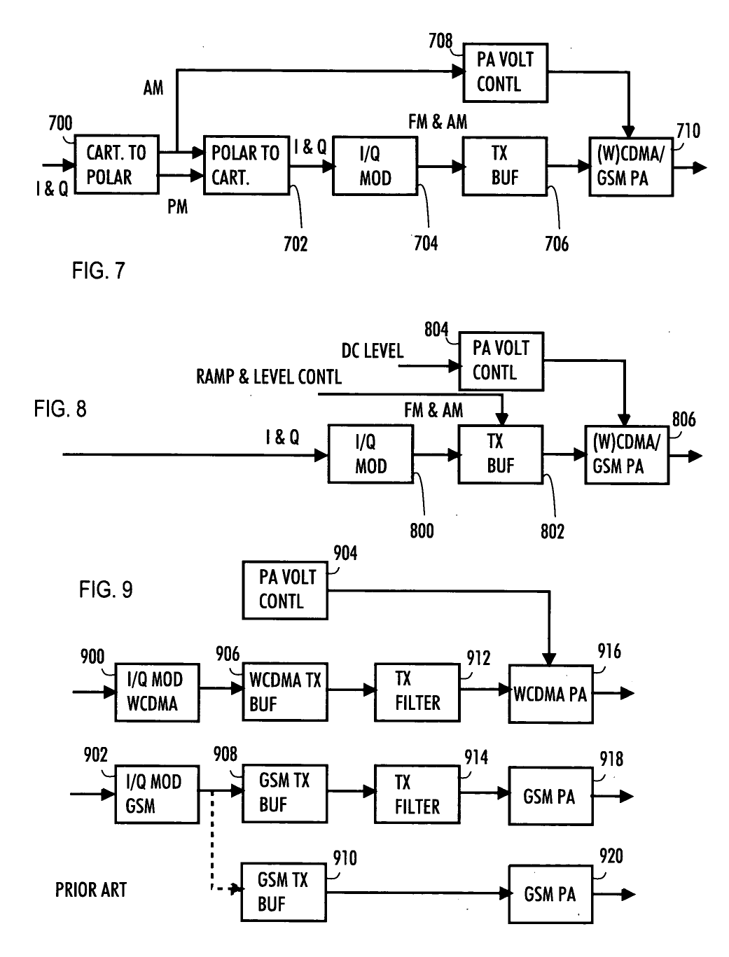

FIG. 7 presents an exemplary configuration used to generate a signal modulated by a modulation method used in EDGE systems that offers a potential for decreasing the amount of needed phase and amplitude predistortion. In this configuration, I and Q signals are first changed to polar form and a phase pre-distortion is added to phase information. Then amplitude (without pre-distortion) and the predistorted phase (the timing between AM and phase modulation must be maintained) are changed back to a Cartesian (I&Q) form. These transforms are carried out in blocks 700, 702.

Then after I/Q modulator 704, the resulting modulated signal (both amplitude and phase were modulated) is amplified by using buffer 706 to a level that affects the wanted compression in the power amplifier. The Output level of the buffer is changed with a wanted output power in order to keep the amount of compression constant.

The original amplitude information is pre-distorted and fed through power amplifier voltage controller 708 to power amplifier 710. By doing this, the power amplifier is used in compression and thus has a good efficiency. In this configuration, less phase and amplitude predistortion is needed than with a constant input amplitude of a power amplifier.

FIG. 8 presents yet another exemplary configuration. This is similar to a case where a traditional I/Q modulator is used.

An I/Q modulator of block 800 generates the wanted modulated signal, for example a signal according to the EDGE standard.

Power control, such as power ramp-up, is carried out with buffer amplifier 802 (amplitude gain control (AGC)) and power amplifier control block 804 is used to give a desired Direct Current (DC) voltage level to the power amplifier. The DC level is controlled in a way that the needed peak power for a used power level is attained. From the buffer amplifier, a signal is fed to power amplifier 806. Power amplifier 806 is working in a linear mode and is not driven to compression.

The same alternatives as presented for the modulation used in EGDE systems are also applicable to CDMA and WCDMA systems. For example, the signals of high power levels can be processed in a manner similar to FIG. 4, 6 or 7 and signals of lower power levels with a conventional I/Q-modulation as presented in FIG. 8 or in FIG. 5, where the power amplifier input signal is generated with the Polar method. The needed phase discontinuity requirement can be achieved with a phase predistortion. When changing from a linear to a non-linear mode, a required phase correction can be added to a phase branch.

In an embodiment, modulation for WCDMA and/or CDMA systems is carried out by using an I/Q modulator, in which case the output signal of an I/Q modulator includes both frequency modulation and amplitude modulation. Power level adjustment is carried out by controlling a controllable buffer amplifier stage and a power amplifier is in linear mode. The Power amplifiers voltage is adjusted according to maximum amplitudes of modulated signals. Next, an example of a prior art transmitter providing 3 GSM bands and 1 WCDMA band and an example of an embodiment of the transmitter according to the invention which provides 4 GSM bands, 4 CDMA bands and 5 WCDMA bands are presented to bring out the usage of common processing blocks according to one embodiment of the invention. As can be seen, an embodiment of the invention provides a less complex multimode transmitter structure.

An example of a prior art transmitter providing 3 GSM bands and 1 WCDMA band is illustrated in FIG. 9. As can be seen, there are separate I/Q modulators 900, 902 for GSM signals and for WCDMA signals. There are also separate buffers for signals of different transmission frequency bands: one buffer for WCDMA signals 906 and two buffers 908, 910 for GSM signals.

In the transmitter, there are band pass filters 912, 914 for WCDMA signals and for GSM signals of the band 850 MHz to 900 MHz. The transmitter also has separate power amplifiers 916, 918, 920 for signals of different transmission frequency bands. One of the GSM power amplifiers is for a frequency band of 850 MHz to 900 MHz and the other is for a 1800/1900 MHz frequency band. Power amplifier voltage control block 904 controls the power amplifier of WCDMA signals.

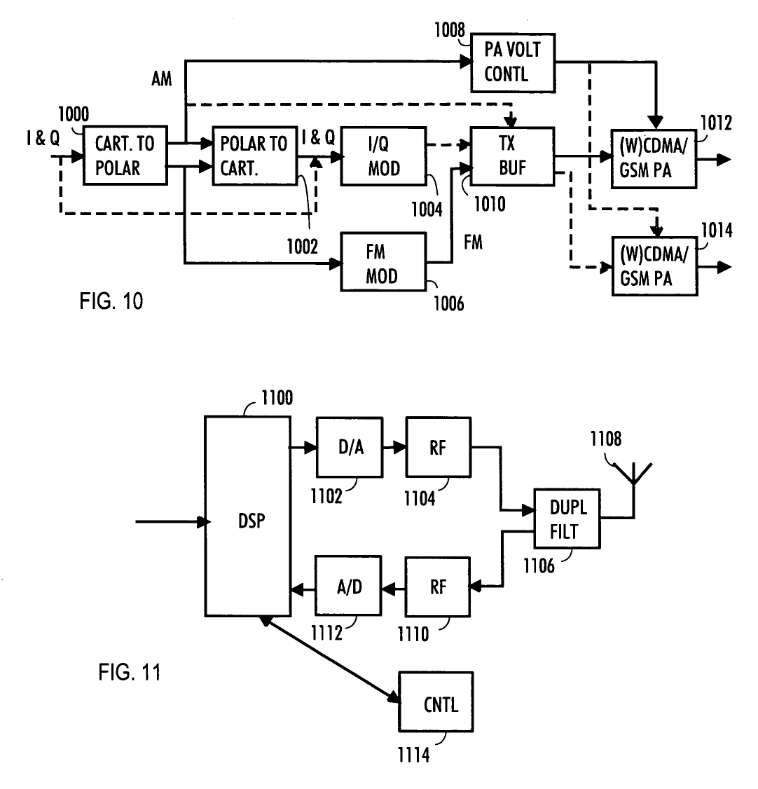

FIG. 10 depicts an example of a transmitter according to an embodiment of the invention providing 4 GSM bands, 4 CDMA bands and 5 WCDMA bands.

The transmitter provides a block 1000 for converting in-phase (I) and quadrature (Q) signals to polar form, that is to say to phase and amplitude components. The phase component may be predistorted in order to compensate distortions caused by a power amplifier. Then, in block 1002, the pre-distorted phase component is converted to FM I and Q signals having a constant amplitude or to phase predistorted I and Q signals with amplitude information. Original I and Q signals are conveyed to block 1000 and/or block 1004 on the basis of the needed modulation. Signal paths are marked in FIG. 10.

There is only one I/Q modulator 1004 and, additionally, one frequency modulator 1006. Another remarkable improvement is that there is only one common buffer 1010 that is used for all signals despite the used modulation method.

It should also be noted that there are only two power amplifiers; one for WCDMA or CDMA signals and GSM signals of a high frequency band 1012 and one for WCDMA or CDMA signals and GSM signals of a low frequency band 1014. Signals are conveyed to the power amplifier on the basis of the frequency band. The used modulation method is not a criterion for the selection of a power amplifier.

Power amplifier voltage control block 1008 controls the power amplifiers according to the selected modulation method and the selected architecture.

FIG. 11 shows an example of a part of a base station. The base station is taken herein as an example of a network element. The embodiments of the invention are especially suitable for network elements designed for local communication systems whose operating range and the number of users is typically quite small. It is obvious to a person skilled in the art that the structure of the network element may vary according to the implementation.

The transceiver uses the same antenna 1108 for receiving and transmitting and, therefore, a duplex filter 1106 is also provided to separate transmission and reception. The antenna may be an antenna array or a single antenna.

In this case, receiver RF parts 1110 also comprise a power amplifier that amplifies the received signal attenuated on a radio path. Typically, RF parts down-convert a signal to an intermediate frequency and then to a base band frequency or straight to a base band frequency. An analogue-to-digital converter 1112 converts an analogue signal to digital form by sampling and quantizing.

A receiver and a transmitter typically share Digital Signal Processing block 1100. Separate DSP-blocks could also be provided for both. Typical functions of a DSP block are, for example, interleaving, coding, spreading and ciphering for transmission and corresponding removal functions for reception, such as de-spreading, de-interleaving, decoding, etc. Digital Signal Processing is known in the art.

In a transmitter, block 1102 converts the signal into an analogue form. RF parts in block 1104 up-convert the signal to a carrier frequency, in other words to a radio frequency either via an intermediate frequency or straight to the carrier frequency. The up-conversion may also be carried out as a part of I/Q modulation. In this example, the RF parts also comprise a power amplifier which amplifies the signal for a radio path.

Control block 1114 controls DSP block 1100. The control block may also be included in the DSP block.

The transceiver may also comprise other parts than those shown in FIG. 11.

The multimode transmitter or a device comprising corresponding functions being located in a network element may be implemented as an ASIC (Application Specific Integrated Circuit) component carrying out selected transmission radio frequency (RF) functions, such as Cartesian to polar and polar to Cartesian conversions, I/Q modulation, FM-modulation and AM-signal generation, the signals being conveyed after modulation to a plurality of power amplifiers. The ASIC component may also be called a module. One potential is to use three integrated circuits: the first carries out digital calculation (changes of coordinates, predistortions, etc), includes VCO, I/Q-modulators, buffers etc, the second carries out power amplifier controlling (amplitude modulation, antenna switch controlling, etc) and the third one may be called a front end module including duplex-filters, antenna switches, etc.

Furthermore, It should be noticed that the multimode transmitter described above can be implemented by using one or more programmable integrated circuits (routers, for instance, may be programmable), since one advantage of the invention is that the same signal generator may be used to generate signals according to different standards. Components and other devices may be recognized and based on that the execution of the program may be branched in different ways, for instance: the type of a power amplifier is recognized and the used configuration is selected based on the recognition. If the power amplifier is linear enough, modulation used in EDGE systems may be carried out by a polar method, otherwise by using an I/Q-modulator.

The multimode transmitter or a corresponding device may also be implemented as a chip set comprising necessary hardware and/or software.

The multimode transmitter or a corresponding device may also be applied as a part of the implementation of other radio frequency functions.

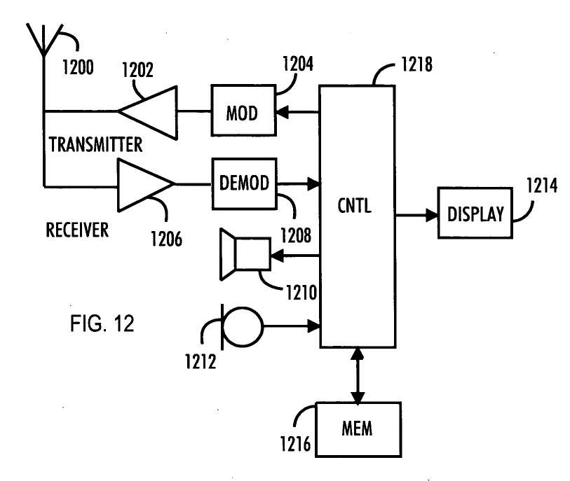

FIG. 12 shows a simplified example of a user device whereto the embodiments of the invention can be applied. The user device is herein taken as an example of a communication device. The device may be a mobile telephone or a microcomputer, for example, without being restricted thereto. It is obvious to a person skilled in the art that the user device may also include elements other than those illustrated in FIG. 12.

The device comprises antenna 1200 by which signals are both transmitted and received via a duplex filter.

The device further comprises transmitter front-end 1202 to amplify, possibly AM modulate and transmit a modulated signal to the antenna, modulator 1204 for modulating the carrier wave by a data signal comprising desired information in accordance with a selected modulation method, receiver front-end 1206 which amplifies the signal supplied from the antenna and down-converts the signal to a selected intermediate frequency or directly to base band, and demodulator 1208 for demodulating the received signal to enable a the separation of a data signal from the carrier wave.

The user device also comprises control block 1218 comprising, for example, control and calculation means for controlling the operation of the different parts of the device, means for processing speech of a user or data generated by the user, such as a digital signal processing (DSP) processor comprising, for example, channel correction functions compensating for interference in the signal caused by a radio channel, A/D converters converting an analogue signal into a digital one by sampling and quantizing a base band signal, D/A converters converting a digital signal to an analogue one by a reverse method, filters at the receiver which filter frequencies outside a desired frequency band or which, in band-restricted systems, restrict the band width of an output at the transmitter, and coding and decoding means for both channel and speech coding.

Furthermore, in spread-spectrum systems, such as wideband code division multiple access (WCDMA used in UMTS) systems, the spectrum of the signal is spread at the transmitter by means of a pseudo random spreading code over a wide band and de-spread at the receiver, in an attempt to increase channel capacity.

The control block also comprises means for arranging the signal to be transmitted and signalling information to conform with the air interface standard of the system used.

The user interface of the device comprises loudspeaker or earpiece 1210, microphone 1212, display 1214 and possibly a keypad and/or a joystick or a similar device. The user interface devices communicate with the control block. FIG. 12 also depicts memory block 1216.

The multimode transmitter or a device comprising corresponding functions being located in a communication device may be implemented as an ASIC (Application Specific Integrated Circuit) component carrying out selected transmission RF functions, such as Cartesian to polar and polar to Cartesian conversions, I/Q modulation, FM modulation and AM signal generation, the signals being conveyed after modulation to a plurality of power amplifiers. The ASIC component may also be called a module. The multimode transmitter or a corresponding device may also be applied as a part of the implementation of other radio frequency functions.

Even though the invention has been described above with reference to an example according to the accompanying drawings, it is clear that the invention is not restricted thereto but can be modified in several ways within the scope of the appended claims.

1. A multimode transmitter comprising:
generating means for generating signals according to different communication standards;
amplifying means for amplifying the signals generated according to the different communication standards; and
conveying means for conveying the signals from the generating means to the amplifying means, the conveying means being shared by the signals generated according to the different communication standards.

2. A multimode transmitter comprising:
generating means for generating signals according to different communication standards;
dividing means for dividing signals into modulation groups on the basis of the used modulation method, which modulation method is determined by a communication standard;
amplifying means for amplifying the signals generated according to the different communication standards;
combining means for combining signals from the modulation groups into a common signal to be conveyed to the amplifying means; and
conveying means for conveying the common signal to the amplifying means.

3. The multimode transmitter of claim 1, further comprising means for generating an in-phase and quadrature modulated signal and means for dividing the in-phase and quadrature modulated signal into an amplitude modulation (AM) signal component and into a signal component to be frequency modulated (FM).

4. The multimode transmitter of claim 1, further comprising means for converting in-phase and quadrature signals to phase and amplitude components, means for differentiating the phase component, means for frequency modulating the phase component, buffer amplifying means, a power amplifier and means for carrying out a power ramp-up and a power level adjustment.

5. The multimode transmitter of claim 1, further comprising means for converting in-phase and quadrature signals to phase and amplitude components, means for differentiating the phase component, means for frequency modulating the phase component, buffer amplifying means wherein an amplitude modulated component is added to the frequency modulated signal, a power amplifier and a power amplifier voltage controller to provide the power amplifier with such a Direct Current (DC) voltage level that the peak power needed for a used power level is attained.

6. The multimode transmitter of claim 1, further comprising means for converting in-phase and quadrature signals to phase and amplitude components, means for generating a frequency modulated signal having a constant amplitude, buffer amplifying means wherein the power level of a signal to be transmitted is raised in such a way that a power amplifier is in a compress mode, a power amplifier and means for carrying out a power control by using an amplitude modulation signal.

7. The multimode transmitter of claim 1, further comprising means for converting in-phase and quadrature signals to phase and amplitude components, means for carrying out phase predistortion, means for converting amplitude and phase components to in-phase and quadrature signals, means for carrying out in-phase and quadrature modulation, a buffer amplifying means wherein the power level of a signal to be transmitted is raised in such a way that a power amplifier is in a compress mode, a power amplifier, means for pre-distorting amplitude information and means for carrying out a power ramp-up and a power level adjustment by using a pre-distorted amplitude modulation signal.

8. The multimode transmitter of claim 1, further comprising means for generating in-phase and quadrature modulated signal, means for carrying out of power control, means for generating predetermined Direct Current (DC) voltage for a power amplifier, a power amplifier.

9. The multimode transmitter of claim 1, further comprising separate amplifying means for upper and lower frequency bands.

10. A module comprising:
generating means for generating signals according to different communication standards;
amplifying means for amplifying the signals generated according to the different communication standards; and
conveying means for conveying the signals from the generating means to the amplifying means, the conveying means being shared by the signals generated according to the different communication standards.

11. A module comprising:
generating means for generating signals according to different communication standards;
dividing means for dividing signals into modulation groups on the basis of the used modulation method, which modulation method is determined by a communication standard;
amplifying means for amplifying the signals generated according to the different communication standards;
combining means for combining signals from the modulation groups into a common signal to be conveyed to the amplifying means; and
conveying means for conveying the common signal to the amplifying means.

12. A communication device comprising:
generating means for generating signals according to different communication standards;
amplifying means for amplifying the signals generated according to the different communication standards; and
conveying means for conveying the signals from the generating means to the amplifying means, the conveying means being shared by the signals generated according to the different communication standards.

13. A communication device comprising:
generating means for generating signals according to different communication standards;
dividing means for dividing signals into modulation groups on the basis of the used modulation method, which modulation method is determined by a communication standard;
amplifying means for amplifying the signals generated according to the different communication standards;
combining means for combining signals from the modulation groups into a common signal to be conveyed to the amplifying means; and
conveying means for conveying the common signal to the amplifying means.

14. A chip set comprising:
generating means for generating signals according to different communication standards;
amplifying means for amplifying the signals generated according to the different communication standards; and
conveying means for conveying the signals from the generating means to the amplifying means, the conveying means being shared by the signals generated according to the different communication standards.

15. A chip set comprising:
generating means for generating signals according to different communication standards;
dividing means for dividing signals into modulation groups on the basis of the used modulation method, which modulation method is determined by a communication standard;
amplifying means for amplifying the signals generated according to the different communication standards:
combining means for combining signals from the modulation groups into a common signal to be conveyed to the amplifying means; and
conveying means for conveying the common signal to the amplifying means.

16. A multimode transmitter configured to:
generate signals according to different communication standards;
amplify the signals generated according to the different communication standards; and
convey the signals from the generating means to the amplifying means, the conveying means being shared by the signals generated according to the different communication standards.

17. A multimode transmitter configured to:
generate signals according to different communication standards;
divide signals into modulation groups on the basis of the used modulation method, which modulation method is determined by a communication standard;
amplify the signals generated according to the different communication standards;
combine signals from the modulation groups into a common signal to be conveyed to the amplifying means; and
convey the common signal to the amplifying means.

18. A module configured to:
generate signals according to different communication standards;
amplify the signals generated according to the different communication standards; and
convey the signals from the generating means to the amplifying means, the conveying means being shared by the signals generated according to the different communication standards.

19. A module configured to:
generate signals according to different communication standards;
divide signals into modulation groups on the basis of the used modulation method, which modulation method is determined by a communication standard;
amplify the signals generated according to the different communication standards;
combine signals from the modulation groups into a common signal to be conveyed to the amplifying means; and
convey the common signal to the amplifying means.

20. A communication device configured to:
generate signals according to different communication standards;
amplify the signals generated according to the different communication standards; and
convey the signals from the generating means to the amplifying means, the conveying means being shared by the signals generated according to the different communication standards.

21. A communication device configured to:
generate signals according to different communication standards;
divide signals into modulation groups on the basis of the used modulation method, which modulation method is determined by a communication standard;
amplify the signals generated according to the different communication standards;
combine signals from the modulation groups into a common signal to be conveyed to the amplifying means; and
convey the common signal to the amplifying means.

22. A chip set configured to:
generate signals according to different communication standards;
amplify the signals generated according to the different communication standards; and
convey the signals from the generating means to the amplifying means, the conveying means being shared by the signals generated according to the different communication standards.

23. A chip set configured to:
generate signals according to different communication standards;
divide signals into modulation groups on the basis of the used modulation method, which modulation method is determined by a communication standard;
amplify the signals generated according to the different communication standards;
combine signals from the modulation groups into a common signal to be conveyed to the amplifying means; and
convey the common signal to the amplifying means.
